(19) United States
(12) Patent Application Publication
(10) Pub. No.: US 2026/0095868 A1
(43) Pub. Date: Apr. 2, 2026

(54) Mobile Devices and Methods for Controlling Radiofrequency Tag Energizing

(71) Applicant: Zebra Technologies Corporation, Lincolnshire, IL (US)

(72) Inventors: Ohad Shatil, Dunwoody, GA (US); Somesh Agrawal, Westbury, NY (US); Satheesh Rajamanickam, Lake Grove, NY (US); Constantin Adrian Sandu, Cambridge (CA); Jonathan Chen, Medford, NY (US)

(73) Assignee: Zebra Technologies Corporation, Lincolnshire, IL (US)

(21) Appl. No.: 19/341,069

(22) Filed: Sep. 26, 2025

Related U.S. Application Data
(60) Provisional application No. 63/701,343, filed on Sep. 30, 2024.
(60) Provisional application No. 63/719,883, filed on Nov. 13, 2024.

(51) Int. Cl. H04W 52/02

(52) U.S. Cl. CPC H04W 52/0261; H04W 52/0251

(57) ABSTRACT

A method includes: maintaining a plurality of sets of energizing parameters for use in energizing radio frequency (RF) tags; obtaining operational data corresponding to a mobile computing device; selecting, based on the operational data, one of the sets of energizing parameters; controlling a wireless communications interface of the mobile computing device to transmit an energizing signal according to the selected set of energizing parameters, the energizing signal including at least one datagram structured according to a wireless networking standard.

### CROSS-REFERENCE TO RELATED APPLICATIONS

This application claims priority from U.S. Provisional Patent Application No. 63/701,343, filed Sep. 30, 2024, and from U.S. Provisional Patent Application No. 63/719,883, filed Nov. 13, 2024. The entire contents of each of the above-referenced applications is incorporated herein by reference.

### BACKGROUND

In a facility storing, processing, and/or otherwise handling items such as packages, apparel, or the like (e.g., retail facilities, warehouses, and the like), radiofrequency (RF) tags may be affixed to at least some of the items. The RF tags may contain item identifiers and/or other item-related data. In some facilities, fixed tag-reading infrastructure can be deployed to capture data from the above tags for subsequent processing. Deploying such infrastructure can be costly and time-consuming.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of a facility containing mobile computing devices and RF tags.

FIG. 2 is a diagram of certain components of a mobile computing device of FIG. 1.

FIG. 3 is a flowchart of a method for energizing RF tags from mobile devices.

FIG. 4 is a diagram of example sets of energizing parameters obtained at block 305 of the method of FIG. 3.

FIG. 5 is a diagram of example energizing parameters in certain profiles from FIG. 4.

FIG. 6 is a flowchart of a method for performing block 315 of the method of FIG. 3.

FIG. 7 is a diagram of an example performance of block 315 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method, comprising: maintaining a plurality of sets of energizing parameters configured to energize radio frequency (RF) tags; obtaining operational data of to a mobile computing device; selecting, based on the operational data of the mobile computing device, one of the sets of energizing parameters; controlling a wireless communications interface of the mobile computing device to transmit an energizing signal according to the selected set of energizing parameters, the energizing signal including at least one datagram structured according to a wireless networking standard.

Additional examples disclosed herein are directed to a mobile computing device comprising: a communications interface; and a processor configured to: maintain a plurality of sets of energizing parameters configured to energize radio frequency (RF) tags; obtain operational data of a mobile computing device; select, based on the operational data of the mobile computing device, one of the sets of energizing parameters; control a wireless communications interface of the mobile computing device to transmit an energizing signal according to the selected set of energizing parameters, the energizing signal including at least one datagram structured according to a wireless networking standard.

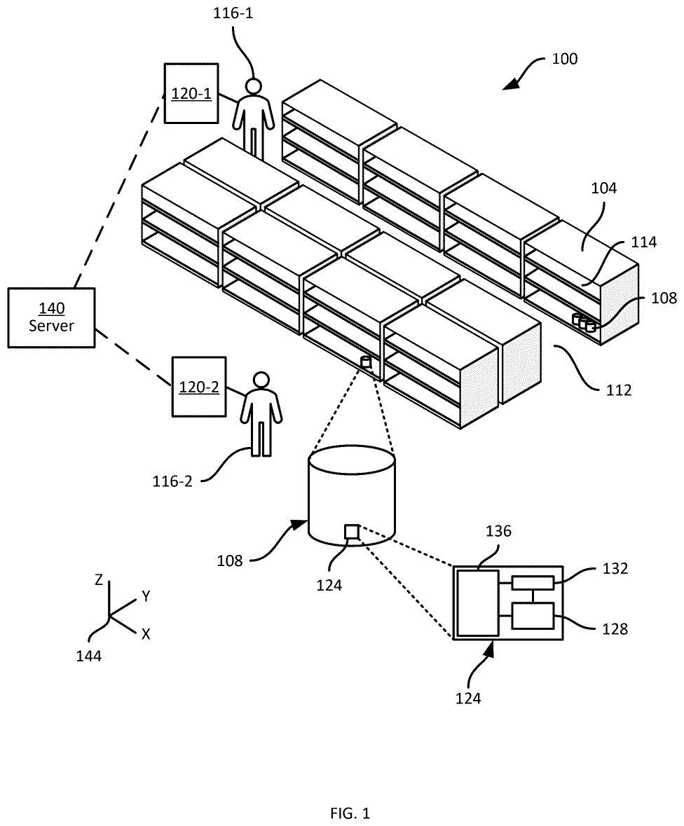

FIG. 1 illustrates an interior of a facility 100, such as a warehouse, a manufacturing facility, a healthcare facility, or the like. The facility 100 includes a plurality of support structures 104 carrying items 108. In the illustrated example, the support structures 104 include shelf modules, e.g., arranged in sets forming aisles 112. In the examples shown in FIG. 1, the support structures 104 include support surfaces 114 supporting the items 108. The support structures 104 can also include pegboards, bins, tables, or the like, in other examples. In some examples, the support structures 104 can include portions of a floor of the facility 100, in addition to or instead of distinct structures disposed on the floor, such as the shelf modules shown in FIG. 1. The facility 100 can have a wide variety of layouts and sizes than the example shown in FIG. 1.

The items 108 may be handled according to a wide variety of processes, depending on the nature of the facility. In the examples discussed below, the facility 100 is a fulfillment facility or the like, and the items 108 disposed on the support structures 104 can be retrieved for shipping from the facility 100 to fulfill incoming orders each indicating identifiers of certain items. The retrieval of an item 108 from a support structure 104 is also referred to as a pick operation. Picks can be performed in the facility 100 by one or more pickers 116-1, 116-2 (collectively referred to as the pickers 116, and generically referred to as a picker 116; similar nomenclature may be used herein for other components with hyphenated reference numbers), such as human workers. Various numbers of pickers can be deployed in the facility 100, e.g., depending on the size of the facility 100, the rate at which orders are received for fulfillment, and the like. Each picker 116 can operate a mobile computing device 120, such as a tablet computer, a smartphone, a wearable computer, or the like. The devices 120 enable the presentation of information to the pickers 116, the capture of information from the picker 116, e.g., indicating completion of a pick task, or the like.

The nature of the workers 116 in the facility and the devices 120 operated by the workers 116 can vary with the type of the facility. For example, in a retail facility, the items 108 may be retrieved from the support structures 104 by customers, and the workers 116 may be staff responsible for stocking the support structures 104.

The facility 100 can contain a plurality of RF tags 124. For example, at least some of the items 108, and in some examples up to all of the items 108, are associated with RF tags. Instead of, or in addition to, the items 108, tags 124 can be disposed on fixed structures within the facility 100, such as the support structures 104 or the like. For example, as shown in FIG. 1, an item 108 can include an RF tag 124 embedded within the item 108, affixed to an exterior of the item 108, or the like. The tag 124 is a passive tag, reliant on energizing radiation from one or more energizing devices. As will be apparent to those skilled in the art, the tag 124 can include a chip 128, e.g., including a non-volatile memory storing an identifier such as a unique tag identifier. The tag 124 can also include an energy storage device 132 such as a capacitor or the like. Further, the tag 124 can include an antenna 136. The antenna 136 is configured to harvest energy from transmissions by the above-mentioned energizing device(s), for storage in the storage device 132.

The tags 124, in this implementation, are ambient RF tags (also referred to as ambient Internet of Things (IoT) tags). An ambient RF tag 124 is configured to harvest energy from “ambient” wireless transmissions over a variable period of time. That is, a given tag 124 can harvest and store energy from wireless transmissions emitted by one or more devices in the facility 100 over a period of seconds, minutes, or in some cases longer periods of time. When the tag 124 has harvested sufficient energy to generate a transmission, the tag 124 can emit a signal containing any of a wide variety of data stored on the tag 124. The data transmitted by a tag 124 can include an identifier of the tag 124, and in some implementations can include sensor data collected by the tag (e.g., temperature, motion data, or the like). That is, a data transmission by a tag 124 need not be performed in response to an interrogation signal or any specific energizing signal. Further, the data transmission need not be directed to any particular device in the vicinity of the tag 124 (e.g., such as the device that energized the tag 124).

As will be apparent to those skilled in the art, the processes described herein can also be applied to other forms of RF tags, such as passive radiofrequency identification (RFID) tags reliant on concurrent energizing and data collection by a given tag-reading device, rather than ambient energizing (potentially from more than one device over the time period(s) mentioned above) decoupled from data transmission.

Energy stored in the device 132 permits the chip 128 to retrieve the above-mentioned identifier (or any other suitable data stored in the chip 128) and transmit the data from the antenna 136. The transmissions used to energize the tag 124 can be in different frequency bands than the transmissions generated by the antenna 136 in response to becoming energized. For example, the transmissions emitted by other devices to energize the tag 124 can have frequencies of about 900 MHz, or frequencies in another suitable portion of the Ultra-High Frequency (UHF) band. In some examples, the tags 124 can be configured to harvest energy from signals in other frequency bands, such as the 2.4 GHz band used by a wide variety of devices for communications according to personal-area network (PAN) standards such as Bluetooth™ and/or wireless local-area network (WLAN) standards such as Wi-Fi (e.g., any member of the family of Institute of Electrical and Electronics Engineers (IEEE) 802.11 standards). The transmissions generated by the tag 124 can be Bluetooth™ Low Energy (BLE) transmissions and/or Wi-Fi transmissions, e.g., with a frequency of around 2.4 GHz.

The tags 124 can be employed for inventory tracking, for example to ascertain the quantity and/or locations of items 108 within the facility. In some examples, inventory tracking can be extended to automated checkout functionality, e.g., by detecting that an item has left the facility with a customer based on changes in the item's location over time. Tracking the presence and/or location of a tag 124 involves periodically reading the tag, e.g., emitting radiation in the UHF band to energize the tag 124, and receiving one or more BLE transmissions from the tag 124. Various other functions can also be implemented by the tags 124, e.g., for environmental monitoring in the facility 100.

Various fixed infrastructure can be deployed in facilities such as the facility 100 to perform the above-mentioned tag reading operations. Tag-reading infrastructure can include tag readers (e.g., referred to as bridges) affixed at various locations within the facility 100 (e.g., walls, ceilings, support structures 104, and the like). The tag-reading infrastructure can also include one or more gateway devices installed in the facility 100. The bridges in such facilities can be configured to collect tag identifiers, and transmit the identifiers to one or more gateway devices (e.g., via wireless links such as Bluetooth). The gateway device(s), in turn, can be configured to transmit the collected tag identifiers to other computing devices, such as on-site or off-site servers, via local and/or wide-area networks.

The above-mentioned fixed infrastructure can be costly and time-consuming to deploy and maintain. As described below, the mobile computing devices 120 are configured to implement tag-energizing functionality, to supplement or replace such fixed infrastructure. The devices 120 are configured to periodically emit signals to energize nearby tags 124. The devices 120 are further configured to capture data transmitted by the tags 124 in response to being energized (whether by the same device(s) 120 capturing the data or by one or more different devices 120). The devices 120 can further transmit collected tag data to a server 140, e.g., via a wireless local-area network (WLAN) or other suitable networking infrastructure, for further processing. In other words, the devices 120 are configured to perform some or all of the functionality described above in connection with fixed bridge and gateway devices.

Supplementing or replacing the above-mentioned fixed infrastructure (e.g., a set of bridge devices for energizing the tags 124 and capturing data therefrom, and one or more gateway devices for relaying tag data from the bridges to a computing device such as the server 140) with the mobile devices 120 may simplify the implementation of tag energizing and data capture functionality in the facility 100. However, the devices 120 are subject to various constraints that may affect their performance in energizing the tags 124 and/or capturing data from the tags 124. For example, the devices 120 can be operated to perform a wide variety of functions aside from energizing the tags 124 and capturing data therefrom. Under some conditions, a given device 120 may have insufficient computational resources to accommodate tag-related operations. Further, the devices 120 are battery-powered, and may therefore in some cases have insufficient stored energy levels to perform tag-related operations without interrupting or otherwise impacting other on-device operations. As discussed below, each device 120 can therefore implement functionality to monitor available resources at the device 120, and in some examples positional data corresponding to the device 120. Positional data can include, for example, a location of the device, e.g., within a facility coordinate system 144.

Each device 120 can further be configured to select parameters for energizing nearby tags 124 based on the available resources and/or positional data (broadly referred to herein as operational data). Further, as discussed below each device 120 can be configured to generate energizing signals according to the selected parameters, and including one or more datagrams structured according to a wireless networking standard. As mentioned above, the tags 124 can be configured to harvest and store energy from transmissions at frequencies used by various wireless networking standards (e.g., around 2.4 GHz). More generally, the tags 124 can be configured to harvest energy from signals at higher frequencies than around 900 MHz.

However, regular communications at such frequencies (such as Bluetooth and Wi-Fi communications) may provide insufficient energy to the tags 124. The devices 120, as set out in detail below, are configured to select and implement energizing parameters that increase the likelihood of providing sufficient harvestable energy to the tags 124 while remaining compliant with wireless networking standards, and mitigating negative impacts on the performance of the devices 120. The energizing transmissions the devices 120 generate via the functionality set out below include one or more datagrams structured according to a suitable wireless network standard (e.g., a Wi-Fi standard).

The functionality set out herein may therefore reduce the reliance of the devices 120 on 900 MHz emissions for energizing the tags 124. A greater number of devices 120 may be equipped with hardware suitable for transmissions at 2.4 GHz or other frequencies used in common wireless networking standards than with hardware suitable for transmissions at 900 MHz. The functionality set out herein may therefore expand the range of devices 120 capable of acting as bridge devices for the tags 124.

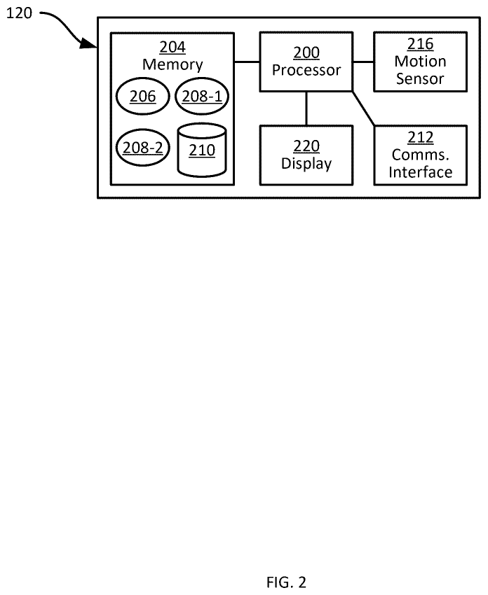

Before discussing the functionality implemented by the devices 120, certain components of the devices 120 are discussed in connection with FIG. 2. Each device 120 can include the components shown in FIG. 2 and discussed below, although it will be understood that the specific implementations of those components may vary between devices 120. For example, while the devices 120 may each include a display, the devices 120 can include different types and/or sizes of display panel.

As shown in FIG. 2, the device 120 includes a processor 200, e.g., one or more central processing units (CPUs), graphics processing units (GPUs), or dedicated hardware controllers such as application-specific integrated circuits (ASICs). The processor 200 is communicatively coupled with a non-transitory computer readable medium such as a memory 204, e.g., a suitable combination of volatile and non-volatile memory elements. The memory 204 stores computer-readable instructions executable by the processor 200 to implement functionality for energizing the tags 124 and capturing data from the tags 124 as described below, e.g., in the form of an application 206. The memory 204 can store additional applications 208-1, 208-2, and the like, e.g., for performing functions unrelated to tag reading (e.g., applications for messaging, barcode scanning, timekeeping, and the like). The memory 204 can also store a repository 210 of configuration data defining energizing parameters, described in greater detail below.

The processor 200 is also coupled with a communications interface 212, enabling the device 120 to communicate with other computing devices, such as the server 140, other devices 120, and the like. The communications interface 212 can include a plurality of transceivers and associated antennas, e.g., each implementing one or more communication technologies. For example, the communications interface 212 can include suitable hardware (e.g., antennas, transceivers, and the like), along with suitable software (e.g., firmware, driver applications and the like) to communicate over one or more of WLANs (e.g., based on Wi-Fi standards), personal area networks (PANs) implemented via Bluetooth or the like, and cellular networks. The communications interface 212 can also include suitable components for performing tag read operations as noted earlier.

The device 120 further includes a motion sensor 216, such as an inertial measurement unit (IMU) including one or more accelerometers, one or more gyroscopes, or the like. The motion sensor 216 can be configured to determine an orientation of the device 120, e.g., as pitch, yaw, and roll angles relative to gravity (e.g., relative to vertical). The motion sensor 216 can also be configured to track movement of the device 120. The processor 200 can be configured to integrate data from the motion sensor 216 with data from the communications interface 212, image sensors (not shown), or the like, to track a location of the device 120 within the coordinate system 144. Various mechanisms will occur to those skilled in the art for location tracking, e.g., via beacons mounted within the facility, optical markers disposed within the facility at predetermined locations, and the like.

The device 120 can also include input and output components, such as a display 220 integrated with a touch panel. The device 120 can include a wide variety of other inputs and outputs, in addition to or instead of the display 220. For example, the device 120 can include inputs such as buttons, keypads, microphones, or the like, and/or outputs such as speakers, indicator lights, and the like. The components of the device 120 can be powered by an onboard battery (not shown), e.g., a rechargeable battery.

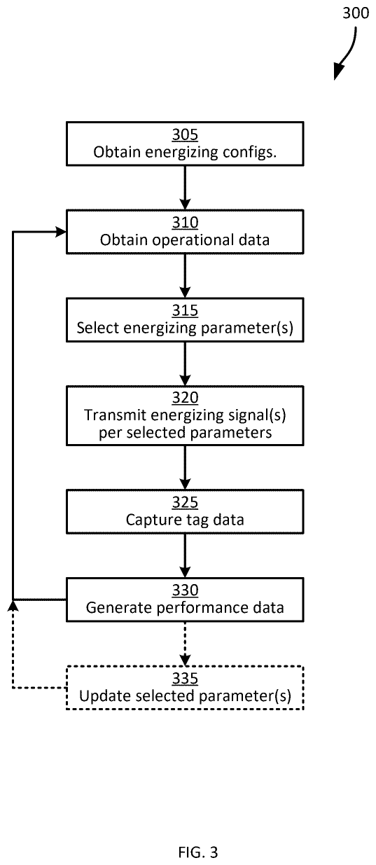

Turning to FIG. 3, a method 300 of energizing the RF tags 124 and capturing data from the tags 124 at a mobile device 120 is illustrated. The method 300 is described below in conjunction with its performance by the processor 200 of a device 120, e.g., via execution of the application 206 by the processor 200, and/or by equivalent dedicated hardware elements as noted earlier. It will be understood that a plurality of devices 120 deployed in the facility 100, up to and including each of the devices 120 in the facility 100, can perform distinct instances of the method 300. As will be apparent to those skilled in the art, performance of the method 300 permits a device 120 to implement either or both of the above-mentioned bridge and the above-mentioned gateway, mitigating or obviating the need for fixed deployment of such devices in the facility 100, while also mitigating the impact of such functions on the performance of other tasks by the device 120. Performance of the method 300 may also enable the devices 120 to provide sufficient energy to the tags 124 to permit the tags 124 to transmit tag data, while using a frequency band above the UHF band, e.g., frequencies of around 2.4 GHz. It will be understood that the functionality detailed herein may also be extended to higher frequency bands, e.g., 5 GHz and 6 GHz bands.

At block 305, the device 120 is configured to obtain configuration data defining one or more sets of energizing parameters. The configuration data can be received, for example, from the server 140 via any suitable network or combination of networks. In other examples, the configuration data can be provided to the device 120 via a direct connection, e.g., with the server 140 or another computing device used for updating and/or management of the devices 120. The configuration data is stored in the repository 210.

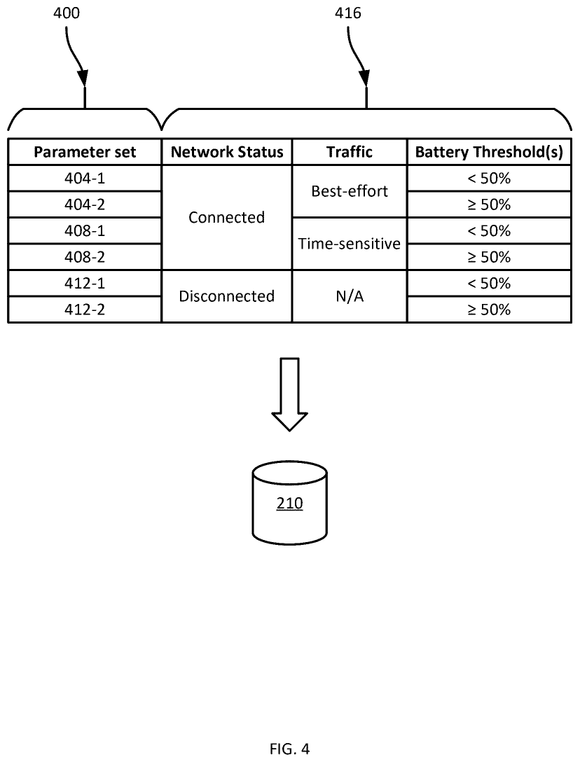

Turning to FIG. 4, example configuration data 400 is illustrated, e.g., as received from the server 140 and stored in the repository 210. The configuration data 400 includes a plurality of energizing profiles, which may also be referred to as energizing definitions. In the illustrated example, the configuration data 400 includes six energizing profiles 404-1, 404-2, 408-1, 408-2, 412-1, and 412-2. As will be apparent in the discussion below, the number of profiles 404, 408, and 412 in the configuration data 400 can be greater than or smaller than the six illustrated. Further, as will be discussed below, the configuration data 400 includes profiles of three different types, each corresponding to a distinct datagram structure used for energizing signals. The profiles 404 correspond to a first datagram type, the profiles 408 correspond to a second datagram type, and the profiles 412 correspond to a third datagram type. In other implementations, fewer than three or more than three types of datagrams can be used for energizing profiles, and the number of types of profile can therefore also vary.

In addition to the energizing profiles 404, 408, and 412, the device 120 can obtain selection criteria 416 corresponding to the configuration data 400. The selection criteria 416 can be received from the server 140, e.g., along with the configuration data 400. The selection criteria, as described further below, are processed by the device 120 based on the operational data to select one of the energizing profiles 404, 408, 412 for use in transmitting energizing signals.

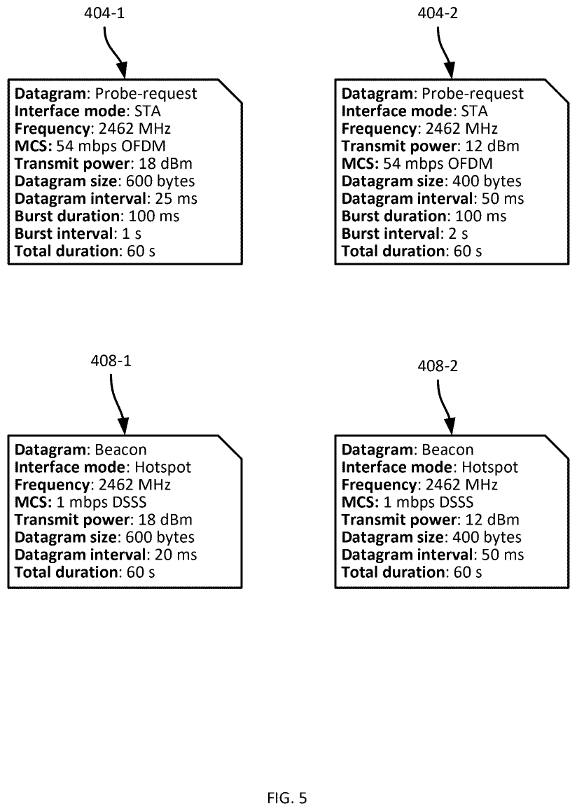

Turning to FIG. 5, example contents for certain profiles in the configuration data 400 of FIG. 4 is illustrated. It will be understood that the energizing parameters shown in FIG. 5 can vary widely between implementations, and are provided simply for the purpose of illustration. The profiles 404-1 and 404-2 correspond to a first datagram type, which in this example is a probe-request datagram (e.g., a Wi-Fi probe-request frame). The profiles 408-1 and 408-2 correspond to a second datagram type, which in this example is a beacon datagram. Examples of beacon datagrams include a Wi-Fi beacon frame, and/or a Fast Initial Link Setup (FILS) Discovery frame, and/or a Wi-Fi unsolicited-probe-response frame. In other words, the profiles 404 define datagrams typically sent by client devices in wireless networks (e.g., also referred to as stations), while the profiles 408 define datagrams typically sent by access points or base stations in wireless networks.

The profiles 404 and 408 each contain energizing parameters defining a datagram type, as well as an interface mode for the communications interface 212 (e.g., selected between a station mode “STA” and an access point mode “Hotspot”). In other examples, additional modes can be implemented, e.g., corresponding to a peer-to-peer mode (e.g., if the device 120 has an active Wi-Fi Direct connection or the like). The profiles 404 and 408 also each contain frequency and modulation and coding scheme (MCS) parameters, as well as transmission power parameters.

The frequency and modulation coding parameters can define, for example, data rates (e.g., in megabits per second, mbps) and/or modulation schemes (e.g., orthogonal frequency divisional multiplex or OFDM, direct sequence spread spectrum or DSSS, and the like). The transmission power parameter can define, for example, the maximum permissible transmission power to use when transmitting the datagrams defined by the relevant profile. The profiles 404 and 408 further define a datagram size, e.g., expressed in bytes or any other suitable unit, as well as a datagram interval (e.g., the time between successive datagrams) and a total duration for the transmission of energizing datagrams. The size of a datagram can be controlled by padding a custom information element (IE) in a standardized datagram type, for example.

The profiles 404, in this example, also include additional timing parameters, such as a burst duration (e.g., the time period over which to transmit a plurality of datagrams according to the datagram interval), and a burst interval (e.g., the time period between successive bursts).

The profiles 412 can define a hybrid configuration including both probe-requests or other station-oriented datagrams, and beacons or other base station-oriented datagrams. The profiles 412 can therefore include both the energizing parameters common to each of the profiles 404 and 408, as well as the parameters specific to the profiles 404. In some examples, the profiles 412 can include distinct parameters for each beacon type (e.g., separate transmission powers for probe-requests and for beacons).

As seen in FIG. 4, certain parameters vary between the profiles for a given type of datagram. For example, the transmission power, datagram timing parameters, and datagram size in the profile 404-1 correspond to more aggressive (e.g., more frequent transmission and/or transmission at higher power and/or longer transmission as a result of increased data volume) datagram transmissions than the profile 404-2. Similarly, the profile 408-1 defines more aggressive energizing datagram transmissions than the profile 408-2. As described further below, the profiles 404, 408, and 412 can define a range of datagram transmissions with varying impacts on the device 120, to accommodate for different ranges of operational data at the device 120 and mitigate negative impacts of datagram transmission by the device 120.

Referring again to FIG. 3, at block 310 the device 120 is configured to obtain operational data. The operational data may reflect local availability of computational resources, at the device 120 itself. For example, the operational data can include a current battery charge level. In some examples, the operational data can also include a current battery temperature. The operational data can further include a utilization level for the processor 200. The utilization level can be, for example, an average over the previous ten seconds (or any other suitable time period), or can be an instantaneous measurement at the time that block 310 is performed. The operational data can further include indicators of which applications 208 are currently being executed by the processor 200.

The operational data can also include data associated with the network connectivity of the device 120. For example, the operational data can include an indication of whether the device 120 is currently connected to another computing device via a local wireless networking standard (e.g., to a Wi-Fi access point, another device 120 via a peer-to-peer connection, or the like). The operational data can also include, when the device 120 does have an active connection, a frequency band and/or channel corresponding to the connection. The operational data can also include, when the device 120 does have an active connection, a traffic type indicator, e.g., indicating the highest traffic type or class currently active at the device 120. As will be understood by those skilled in the art, wireless network traffic can be classified broadly into a “best-effort” class that is not time-sensitive (e.g., file transfers, non-multimedia browser data, and the like), and a “time-sensitive” class, e.g., including multimedia such as voice and/or video calls. Additional classifications may be applied to traffic, e.g., indicating specific applications or types of time-sensitive traffic.

The operational data can also include, in some examples, positional data corresponding to the location and/or orientation of the device 120, e.g., within the facility 100. The processor 200 can, for example, obtain a location and orientation of the device 120 from the motion sensor 216, e.g., defined in the coordinate system 144.

At block 315, the device 120 is configured to select a set of energizing parameters, e.g., by selected one profile from the configuration data 400, based on the operational data from block 310. The selection at block 315 can be performed in a variety of ways. For example, referring again to FIG. 4, the selection at block 315 can be performed by comparing the operational data, or at least certain portions thereof, to the selection criteria 416.

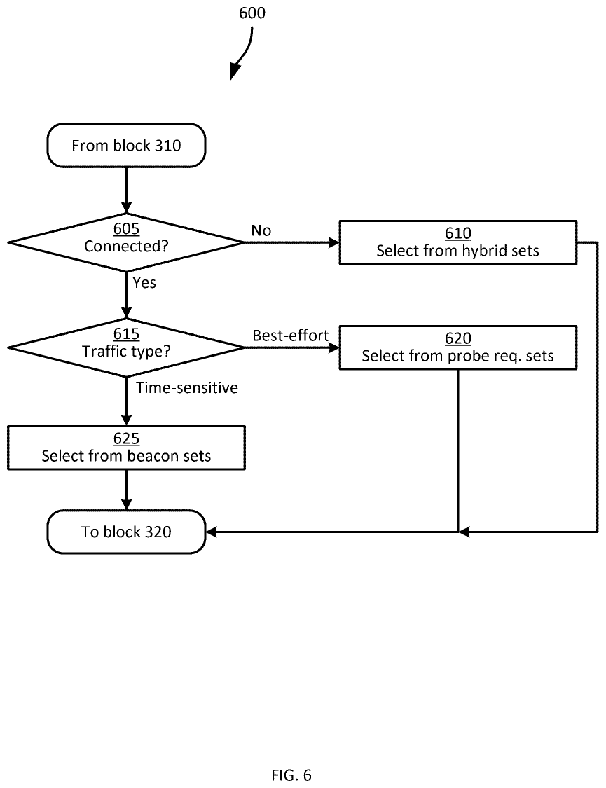

Turning to FIG. 6, an example method 600 for selecting energizing parameters (e.g., for performing block 315) is illustrated. The method 300 is described below in conjunction with its performance by the processor 200 of a device 120, e.g., via execution of the application 206 by the processor 200, and/or by equivalent dedicated hardware elements as noted earlier.

At block 605, the device 120 is configured to determine, from the operational data, whether there is an active network connection. When the determination at block 605 is negative (e.g., when the device 120 is not currently connected to a peer device 120, an access point, and/or a client device while functioning as an access point), the device 120 proceeds to block 610. At block 610, the device 120 is configured to select an energizing profile 412. That is, in this implementation, when the device 120 does not have an active local wireless connection, the device is configured to select a set of energizing parameters defining hybrid transmission of two datagram types, as defined in the profiles 412. The hybrid profile type may be more resource-intensive at the device 120, and may involve more frequent transmissions by the device 120. The profiles 412 may therefore be suitable for situations when the device 120 is not currently conducting other wireless communications.

When the determination at block 605 is affirmative, the device 120 proceeds to block 615. At block 615, the device 120 is configured to compare the traffic type specified in the operational data to the selection criteria 416. When the traffic type is best-effort (or any other suitable traffic type indicator corresponding to latency-tolerant traffic), the device 120 proceeds to block 620, and selects a profile 404 (e.g., corresponding to probe-request datagrams). When the traffic type is time-sensitive (or any other traffic type indicator corresponding to latency-intolerant traffic) the device 120 proceeds to block 625. At block 625, the device 120 selects a profile 408 (e.g., corresponding to beacon datagrams).

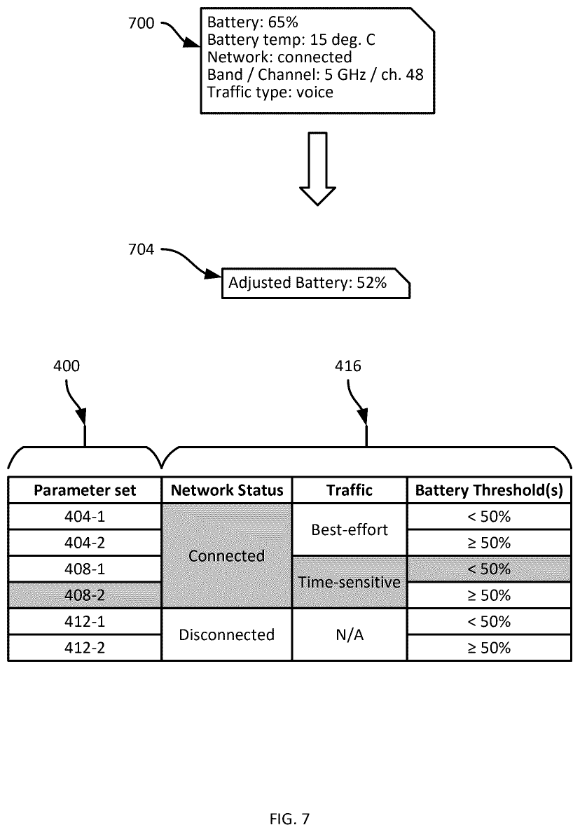

The selection of a profile from a given profile type is based, for example, on the battery level and temperature, as illustrated in connection with FIG. 7, discussed below. Following selection of a profile at block 610, 620, or 625, the device 120 proceeds to block 320.

Referring to FIG. 7, the profile selection process is illustrated based on example operational data 700 and the selection criteria 416 introduced in FIG. 4. As seen in FIG. 7, the operational data 700 indicates an active connection, and the determination at block 605 is therefore affirmative. The affirmative determination at block 605 corresponds to a narrowing of the compatible configuration data 400 to the profiles 404 and 408 (e.g., excluding the profiles 412), as indicated by the shading of the “network status” criterion labelled “connected”.

The device 120 can next select between the profiles 404 and 408 based on traffic type. In this example, the operational data 700 indicates that the traffic type on the active connection includes voice traffic, which is time-sensitive. Therefore, the device 120 proceeds from block 615 to block 625, illustrated by shading of the “traffic type” criterion labelled “time-sensitive”. In other words, the device 120 has eliminated the profiles 404 from the selection process. The device 120 is then configured, at block 625, to select between the profiles 408-1 and 408-2, based on the level and (in this example) temperature of the battery of the device 120. The device 120 can, for example, generate an adjusted battery level by scaling the battery level according to a difference between the actual battery temperature and a reference battery temperature. For example, the actual battery level of 65% can be scaled downwards as a result of the ten-degree difference between a reference battery temperature of 25 degrees C. and the actual battery temperature of 15 degrees C. (reflecting the fact that colder temperatures are likely to reduce battery capacity).

The device 120 can then compare the adjusted battery level 704 to the “battery threshold” criterion for each of the profiles 408. The adjusted battery level 704 satisfies the battery level criterion for the profile 408-2, which is therefore selected.

Returning to FIG. 3, at block 320, the device 120 is configured to perform a tag energizing operation using the selected parameters from block 320. That is, the processor 200 is configured to control the communications interface 212 to emit one or more energizing signals (e.g., via a Wi-Fi antenna) comprising datagrams structured according to the parameters in the selected energizing profile. As will be apparent to those skilled in the art, in some examples the performance of the method may end following block 320. For example, it is possible that tags 124 in the vicinity of the device 120 emitting energizing signals are not sufficiently energized to transmit tag data. Those tags 124 may, for example, harvest and store some energy from the signals emitted at block 320, and await further energizing signals before transmitting tag data.

In other examples, whether in response to the energizing signals transmitted at block 320 or in response to energizing signals from other sources, one or more tags 124 in the vicinity of the device 120 may transmit tag data. At block 325, the device 120 can be configured to capture tag data from one or more tags 124, e.g., including tag identifiers from those tags 124. The tags 124 may have transmitted their respective tag data in response to being energized by the above signals from block 320, but may also have been energized by other sources.

The device 120 can also be configured to relay each unique tag identifier collected at block 325 (as will be apparent, each tag 124 may transmit multiple packets of data containing the same identifier, dependent on how long the tag 124 remains energized, and/or on how frequently the tag 124 is able to harvest sufficient energy to begin transmitting tag data) to the server 140.

At block 330, the device 120 is configured to generate performance data based on the tag data collected at block 325. For example, for each tag identifier received at block 325, the device 120 can be configured to generate one or more performance attributes. The performance attributes can include a received signal strength indicator (RSSI) for the corresponding tag identifier. If more than one response was received from the same tag 124, the RSSI can be an average of the received responses, or the lowest RSSI value.

The performance attributes can also include one or more timing measurements, including for example a time between emission of the energizing signal by the device 120, and receipt of the first response from the given tag 124. Another example timing measurement can include an average time between responses for the given tag 124, when more than one response was received from that tag 124.

The device 120 can optionally, at block 335, modify energizing parameters in the selected profile (e.g., the profile 408-1 in the above example), based on performance data from block 330. For example, the performance data from block 330 can be used to determine an adjustment to apply to any one or more of the size and timing parameters in the profile 408-1. For example, if the average tag RSSI from block 330 is below a threshold, the device 120 can be configured to increase the size parameter, and/or decrease the timing parameters (to increase the frequency and/or number of datagrams sent). Conversely, if the average tag RSSI from block 330 is above a threshold, the device 120 can decrease the size parameter, and/or increase the timing parameters (to increase the frequency and/or number of datagrams sent).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
maintaining a plurality of sets of energizing parameters configured to energize radio frequency (RF) tags;
obtaining operational data of to a mobile computing device;
selecting, based on the operational data of the mobile computing device, one of the sets of energizing parameters;
controlling a wireless communications interface of the mobile computing device to transmit an energizing signal according to the selected set of energizing parameters, the energizing signal including at least one datagram structured according to a wireless networking standard.

2. The method of claim 1, further comprising:
obtaining at least one identifier from an RF tag; and
sending the at least one identifier to a further computing device.

3. The method of claim 1, further comprising:
in response to obtaining the at least one identifier from the RF tag, determining tag read performance data corresponding to the RF tag; and
updating the selected energizing parameters based on the tag read performance data.

4. The method of claim 1, wherein the datagram includes a management frame according to a wireless networking standard selected from the group consisting of Wi-Fi and Bluetooth.

5. The method of claim 4, wherein the datagram includes at least one of a probe request or a beacon.

6. The method of claim 4, wherein the energizing parameters include at least one of an interval between datagrams and a datagram size.

7. The method of claim 1, wherein the operational data comprises at least one of:
a battery level of the mobile computing device,
a processor utilization level of the mobile computing device,
an indication of at least one application executed by the processor,
a battery temperature of the mobile computing device,
a wireless network connection status of the mobile computing device,
a location of the mobile computing device,
an orientation of the mobile computing device, or
a current wireless network traffic class of the mobile computing device.

8. The method of claim 1, wherein selecting the one of the sets of energizing parameters comprises:
determining whether the operational data satisfies criteria corresponding to each of the sets;
selecting the one of the sets corresponding to criteria satisfied by the operational data.

9. The method of claim 8, wherein the criteria include a battery level threshold.

10. The method of claim 9, wherein the criteria include an indication of whether the mobile computing device is connected to a wireless network.

11. A mobile computing device comprising:
a communications interface; and
a processor configured to:
maintain a plurality of sets of energizing parameters configured to energize radio frequency (RF) tags;
obtain operational data of a mobile computing device;
select, based on the operational data of the mobile computing device, one of the sets of energizing parameters;
control a wireless communications interface of the mobile computing device to transmit an energizing signal according to the selected set of energizing parameters, the energizing signal including at least one datagram structured according to a wireless networking standard.

12. The mobile computing device of claim 11, wherein the processor is further configured to:
obtain at least one identifier from an RF tag; and
send the at least one identifier to a further computing device.

13. The mobile computing device of claim 11, wherein the processor is further configured to:
in response to obtaining the at least one identifier from the RF tag, determine tag read performance data corresponding to the RF tag; and
update the selected energizing parameters based on the tag read performance data.

14. The mobile computing device of claim 11, wherein the datagram includes a management frame according to a wireless networking standard selected from the group consisting of Wi-Fi and Bluetooth.

15. The mobile computing device of claim 14, wherein the datagram includes at least one of a probe request or a beacon.

16. The mobile computing device of claim 14, wherein the energizing parameters include at least one of an interval between datagrams and a datagram size.

17. The mobile computing device of claim 11, wherein the operational data comprises at least one of:
a battery level of the mobile computing device,
a processor utilization level of the mobile computing device,
an indication of at least one application executed by the processor,
a battery temperature of the mobile computing device,
a wireless network connection status of the mobile computing device,
a location of the mobile computing device,
an orientation of the mobile computing device, or
a current wireless network traffic class of the mobile computing device.

18. The mobile computing device of claim 11, wherein the processor is further configured to select the one of the sets of energizing parameters by:
determining whether the operational data satisfies criteria corresponding to each of the sets;
selecting the one of the sets corresponding to criteria satisfied by the operational data.

19. The mobile computing device of claim 18, wherein the criteria include a battery level threshold.

20. The mobile computing device of claim 19, wherein the criteria include an indication of whether the mobile computing device is connected to a wireless network.
